(19) United States
(12) Patent Application Publication
(10) Pub. No.: US 2002/0159400 A1
(43) Pub. Date: Oct. 31, 2002

(54) Two-wire ethernet system for digital subscriber line communications

(76) Inventors: Kyu Ho Park, Daejeon (KR); Hyun Jin Choi, Suwon-si (KR)

Correspondence Address: David A. Einhorn, Esq., Anderson Kill & Olick, P.C., 1251 Avenue of the Americas, New York, NY, 10020, US

(21) Appl. No.: 09/969,259

(22) Filed: Oct. 1, 2001

(30) Foreign Application Priority Data
Feb. 26, 2001 (KR) 2001-009684

(51) Int. Cl. H04B 1/44; H04J 3/16

(52) U.S. Cl. 370/282; 370/466

(57) ABSTRACT

An Ethernet system includes a plurality of LAN cards each of which is embodied in a computing device and a switching hub connected to the LAN cards, each LAN card and the switching hub being connected by one pair of signal lines. In order to perform the data communications between the LAN card and the switching hub through one pair of signal lines, each of the LAN card and the switching hub further includes, in addition to a PHY and a MAC, a first control logic circuit for establishing a data transmission speed, a duplex mode, a link mode and an auto-negotiation activation state to have predetermined states, which are to be stored in the PHY and the MAC, and a second control logic circuit for executing a data collision and loop-back avoidance mechanism.

### FIELD OF THE INVENTION

The present invention relates to an Ethernet system; and, more particularly, to an apparatus for implementing high-speed data communications between a local area network (LAN) card and a switching hub by employing a two-wire transmission channel.

### BACKGROUND OF THE INVENTION

In applications of an Ethernet system, data communications in an Ethernet environment are performed through a 4 or 8-wire transmission channel.

Referring to FIG. 1, there is illustrated a schematic block diagram of a typical Ethernet system configured in the Ethernet environment defined in the IEEE 802.3 standard.

The typical Ethernet system comprises at least one LAN card 10 embodied in, e.g., a personal computer (PC), and a switching hub 20, which are connected to each other through an unshielded twisted pair (UTP) cable 30 consisting of 4 or 8 signal lines. For instance, among the 8 signal lines, the 1^{st}, 2^{nd}, 3^{rd} and 6^{th} signal lines are used as output lines TX+ and TX− and input lines RX+ and RX−, respectively, to transmit or receive Ethernet data and the remaining 4 signal lines are used as reference voltage levels of the input and output lines.

Meanwhile, an Ethernet system employing the 4-wire transmission channel uses only 4 signal lines, i.e., the 1^{st}, 2^{nd}, 3^{rd} and 6^{th} signal lines, required to transceive data among the UTP cable 30 having the 8 signal lines.

As a preliminary test for performing the data communications, the LAN card 10 and the switching hub 20 exchange a normal link pulse (NLP) signal through the output and input lines TX+, TX−, RX+ and RX− of the UTP cable 30, thereby executing a link status examination process through which it is checked whether or not each link partner is connected and normally operates. Herein, the LAN card 10 becomes a link partner of the switching hub 20, and vice versa.

As a result of the preliminary test, if the checking result is determined positive, the Ethernet system finally becomes actuated to thereby transceive Ethernet data between the link partners. Then, the LAN card 10 and the switching hub 20 perform auto-negotiation (AN) through the signal lines of the UTP cable 30 to determine a maximum data transmission speed, e.g., 10 Mbps or 100 Mbps, a duplex mode, e.g., a half duplex mode or a full duplex mode, and the like, executable therebetween.

Meanwhile, since it is not cost-effective and is difficult to establish leased lines for accomplishing the high-speed data communications in apartments, hotels and the like, recently, there has been proposed an approach using a telephone wire so as to implement higher speed data communications, e.g., of several Mbps, than a conventional modem.

As the methods for use at homes to carry out the high-speed data communications of several Mbps through the use of the telephone wire, there are an asymmetric digital subscriber line (ADSL) system and the Ethernet system using 4 signal lines. The ADSL system uses a DSL modem and the Ethernet system employs a LAN card and a switching hub as shown in FIG. 1.

Although the DSL modem is dozen times faster than conventional modems of a few dozen Kbps, it is substantially more expensive than the two-wire Ethernet system.

Accordingly, there is a need to provide each home with the two-wire Ethernet system.

### SUMMARY OF THE INVENTION

It is, therefore, an object of the present invention to provide an apparatus capable of performing high-speed data communications in an Ethernet environment by using a 2-wire transmission channel without deteriorating its performance.

In accordance with a preferred embodiment of the present invention, there is provided an Ethernet system for performing data communications between two link partners, which comprises:

a LAN card;

a switching hub, connected to the LAN card, for performing the data communications with the LAN card; and

a pair of signal lines for connecting the LAN card and the switching hub,

wherein the LAN card and the switching hub become the link partners and each of them includes:

a physical layer interface (PHY), which follows the IEEE standard 802.3 and contains two output terminals TX+ and TX− and two input terminals RX+ and RX−, for forming an interface with its link partner, wherein the output terminal TX+ and the input terminal RX+ are connected together to one of the signal lines and the output terminal TX− and the input terminal RX− are connected to the other of the signal lines;

a controller (MAC or switching controller), which follows the IEEE standard 802.3, for transceiving data and control signals with the PHY; and

a control circuit, called MI controller (MIC) (or RMIC in case of RMII protocol) in the present invention, for establishing a data transmission speed, a duplex mode, a link mode and an auto-negotiation (AN) activation state to be stored in the PHY and the controller so as to perform the data communications using the pair of signal lines.

In accordance with another preferred embodiment of the present invention, each of the LAN card and the switching hub further includes an additional control logic circuit, called MII controller (MIIC or RMIIC in case of RMII protocol) in the present invention, for executing a data collision avoidance and loop-back prevention mechanisms.

### BRIEF DESCRIPTION OF THE DRAWINGS

The above and other objects and features of the present invention will become apparent from the following description of preferred embodiments given in conjunction with the accompanying drawings, in which:

FIG. 1 is a block diagram of a typical Ethernet system;

FIG. 2 provides a block diagram of an Ethernet system in accordance with a first embodiment of the present invention;

FIG. 3 describes a block diagram of an Ethernet system in accordance with a second embodiment of the present invention;

FIG. 4 illustrates a block diagram of an Ethernet system in accordance with a third embodiment of the present invention;

FIGS. 5A and 5B show proposed configurations of some of basic registers and additional registers in a PHY, respectively; and

FIGS. 6A to 6H depict timing diagrams of signals generated in an operation of the Ethernet system in accordance with the present invention.

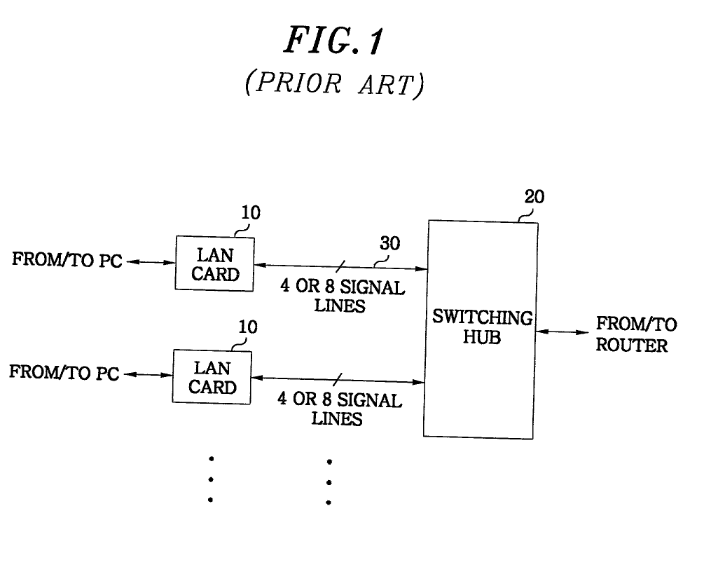

### DETAILED DESCRIPTION OF THE PREFERRED EMBODIMENTS

While referring to the drawings, the preferred embodiments of the present invention will now be explained in detail.

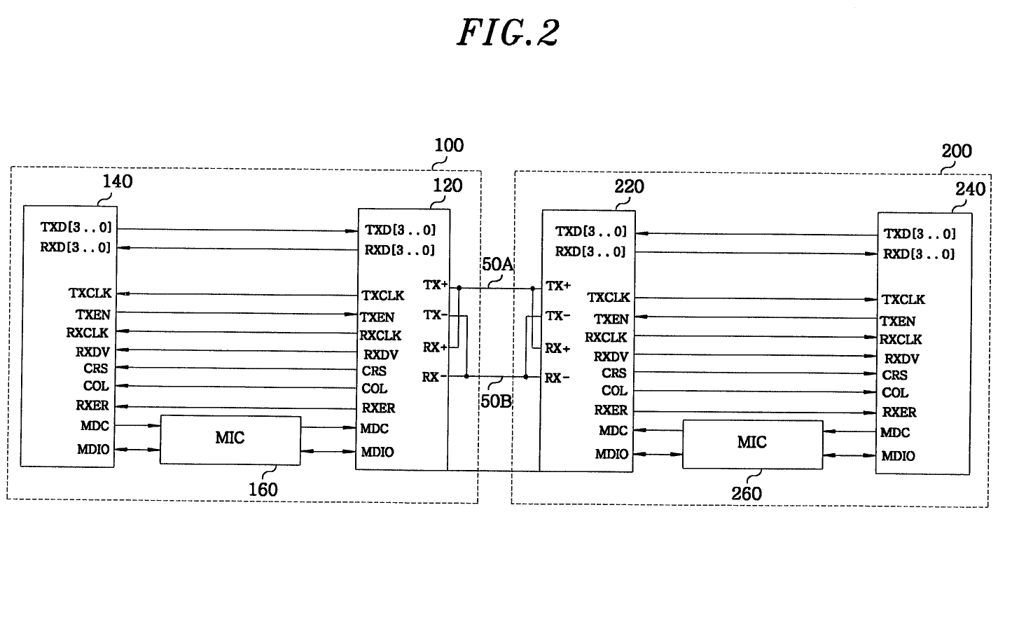

Referring to FIG. 2, there is shown a block diagram of an Ethernet system in accordance with a first embodiment of the present invention.

The inventive Ethernet system comprises a LAN card 100 and a switching hub 200, which execute data communications therebetween through a 2-wire transmission channel, i.e., one pair of signal lines 50A and 50B.

In FIG. 2, although there is shown only one LAN card 100 connected to the switching hub 200 for the simplicity of explanation, it can be understood that the switching hub 200 has multiple ports capable of accommodating a plurality of LAN cards.

The LAN card 100 is, e.g., an on-board LAN card embodied in a computer in a small area such as homes and offices in a building, and basically includes a physical layer interface (PHY) 120, which follows the specification of, e.g., IEEE 802.3 standard and a media access controller (MAC) 140, which also follows the specification of, e.g., IEEE 802.3 standard. In accordance with the first embodiment of the present invention, the LAN card 100 further includes a management interface (MI) controller (MIC) 160 between the PHY 120 and the MAC 140 for implementing the data communications with the switching hub 200 through the pair of signal lines 50A and 50B.

Meanwhile, the switching hub 200 collects Ethernet data packets from either LAN cards connected thereto or external routers (not shown), and then distributes the collected data packets to the LAN cards or the external routers. For this purpose, the switching hub 200 employs a physical layer interface (PHY) 220 and a switch controller 240. Like the LAN card 100, in accordance with the first embodiment of the present invention, the switching hub 200 also includes an MI controller (MIC) 260 between the PHY 220 and the switch controller 240 so as to carry out the data communications executed by transceiving data packets through the signal lines 50A and 50B.

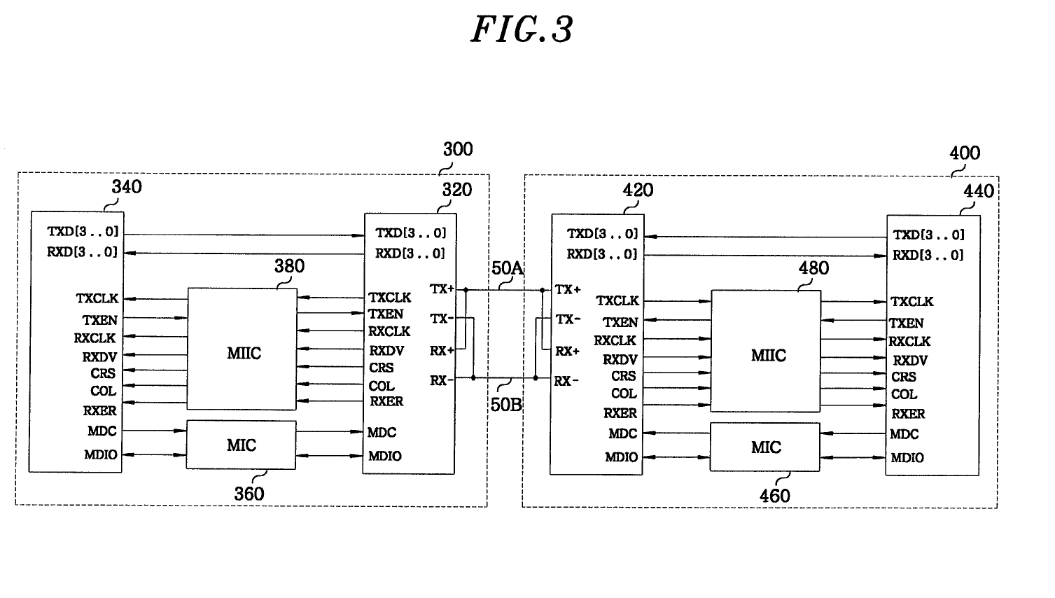

In the switching hub 200, the switch controller 240 contains a logic circuit for performing substantially identical functions to those of the MAC 140 in the LAN card 100 and uses a media independent interface (MII), which follows the specification of, e.g., IEEE 802.3 standard. Moreover, the switch controller 240 of the switching hub 200 can use a reduced pin count media independent interface (RMII), which will be explained later with reference to FIG. 4 showing another embodiment of the present invention.

As described in FIGS. 2 and 3 showing two preferred embodiments of the present invention, in the MII, the PHY 120 or 220 and the MAC 140 or the switch controller 240 are connected through 9 principal wires carrying the following signals: a transmit data signal TXD[3 . . . 0], a receive data signal RXD[3 . . . 0], a transmit clock signal TXCLK, a transmit enable signal TXEN, a receive clock signal RXCLK, a receive data valid signal RXDV, a carrier sense signal CRS, a collision detection signal COL and a receive error signal RXER.

Meanwhile, in accordance with the present invention, output terminals TX+ and TX− and input terminals RX+ and RX− of the LAN card 100 and the switching hub 200 are connected to the signal lines 50A and 50B as described in FIGS. 2 to 4. For example, the output terminal TX+ and the input terminal RX+ are attached to the signal line 50A while the output terminal TX− and the input terminal RX− are connected to the signal line 50B.

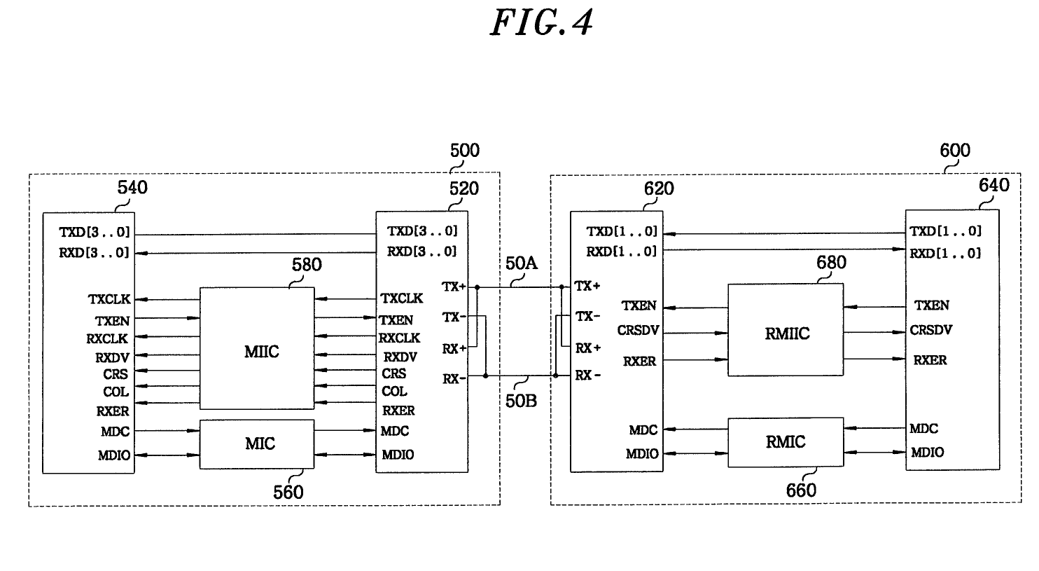

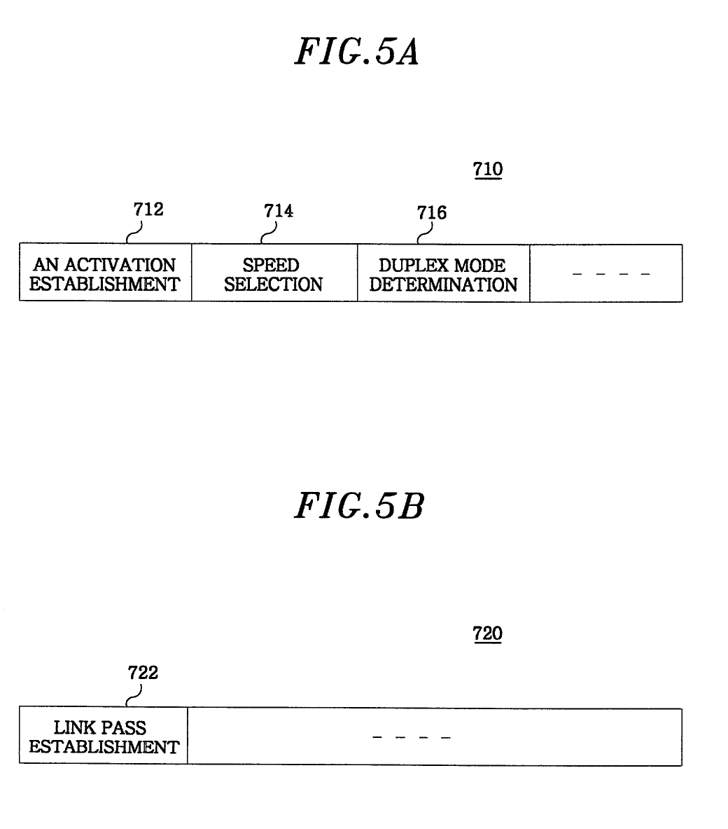

The PHYs 120 and 220 included in the LAN card 100 and the switching hub 200, respectively, form an interface between the link partners, i.e., the switching hub 200 and the LAN card 100, and each of the PHYs 120 and 220 contains therein a basic register 710 and an additional register 720 as shown in FIGS. 5A and 5B, which follow the IEEE 802. 3 standard.

The basic register 710 essentially contains an auto-negotiation AN activation establishment region 712 for storing a value deciding whether or not to perform the AN between the link partners, a speed selection region 714 and a duplex mode determination region 716, which store values used in choosing a specific data transmission speed and a duplex mode, respectively, when the Ethernet data packets are transceived between the link partners. In accordance with the present invention, the values stored in the regions 712, 714 and 716 are initialized with predetermined default values or values determined by their corresponding MAC 140 or switch controller 240.

In the meantime, the additional register 720 optionally contains a link pass establishment region 722 for storing a value used in determining whether or not to examine normal link pulse (NLP) signals transmitted between the link partners. The value stored in the link pass establishment region 722 is initialized with a default value or a value determined by its corresponding MAC 140 or switch controller 240.

In accordance with the present invention, since the LAN card 100 and the switching hub 200 are connected to each other through the pair of signal lines 50A and 50B, they need to include a control logic circuit therein to smoothly carry out the data communications therebetween. Therefore, as shown in FIG. 2, the MIC 160 is used to connect the MAC 140 with the PHY 120 of the LAN card 100 while the MIC 260 is employed to connect the PHY 220 to the switch controller 240 of the switching hub 200. The MIC 160 (or 260) performs a process for setting the registers 710 and 720 in the PHYs 120 and 220 to have specific values, which are the default values or the values determined by the MAC 140 (or the switch controller 240). As a result, the LAN card 100 and the switching hub 200 can transceive the Ethernet data packets through the pair of signal lines 50A and 50B.

The operations of the MICs 160 and 260 will be explained hereinafter. Since the configurations of the LAN card 100 and the switching hub 200 are substantially identical with each other, for the simplicity of explanation, only the operation of the MIC 160 of the LAN card 100 will be described in detail.

According to the description of the prior art, the PHY 120 of the LAN card 100 exchanges NLP signals with the PHY 220 of the switching hub 200 so as to execute a link status examination process through which it is checked out whether or not its link partner, i.e., the switching hub 200, is connected thereto and normally operates.

Since, however, the input terminal RX+ (or RX−) and the output terminal TX+ (or TX−) of the LAN card 100 are tied to each other through one signal line 50A (or 50B) as shown in FIG. 2, and thus the PHY 120 may receive back an NLP signal outputted therefrom and recognize it as an NLP signal transmitted from the PHY 220 of the switching hub 200, it is impossible for the PHY 120 to successfully execute the link status examination process only by checking out the NLP signal inputted thereto through its input terminal RX+ (or RX−).

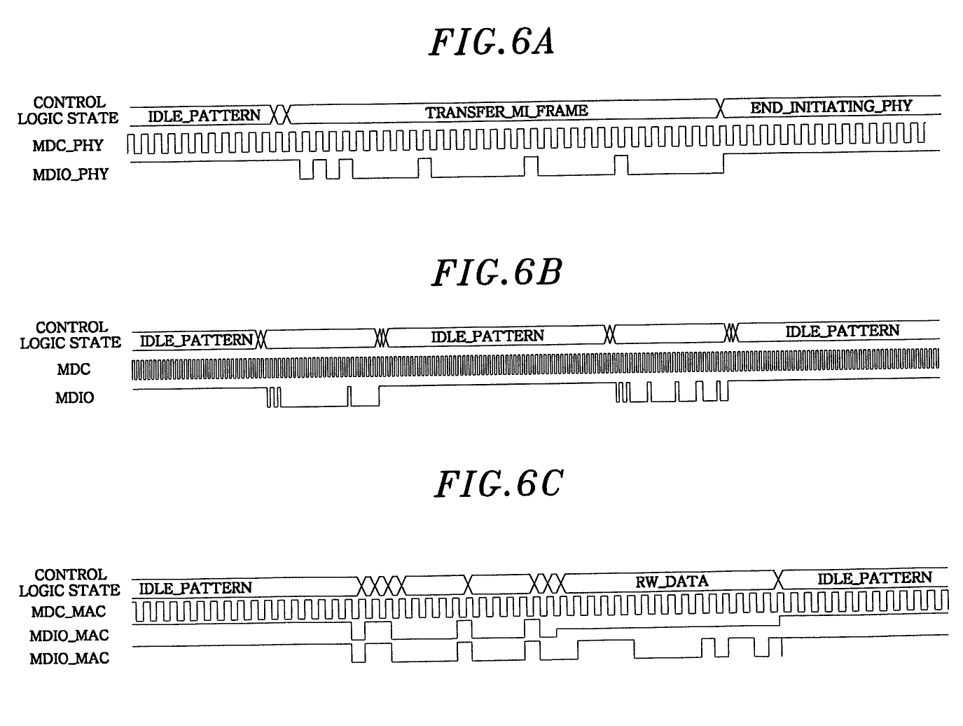

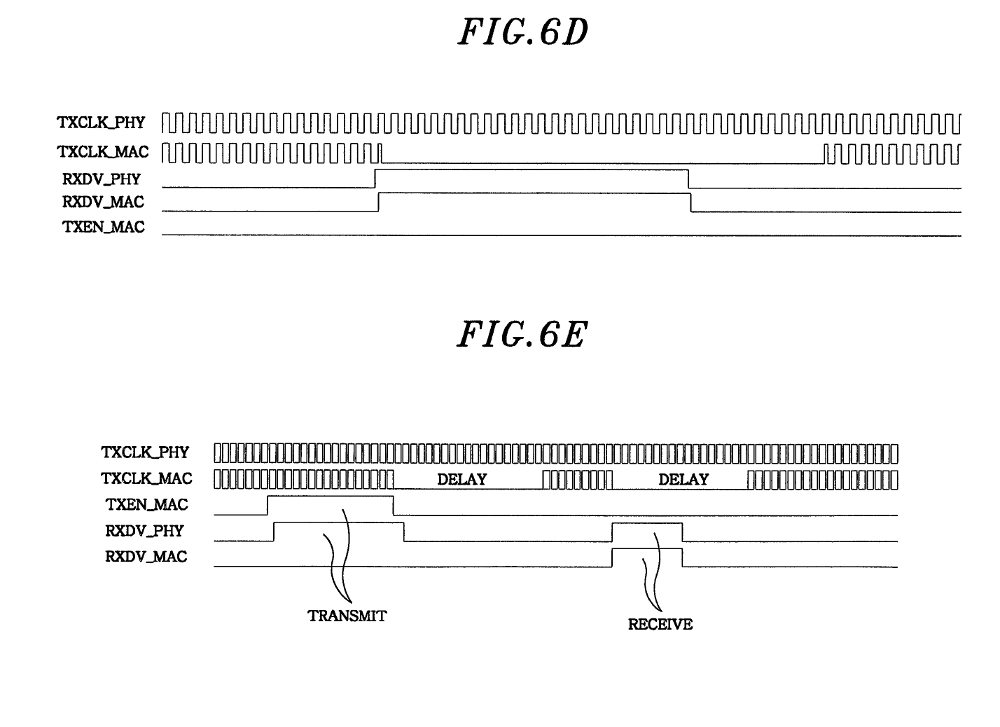

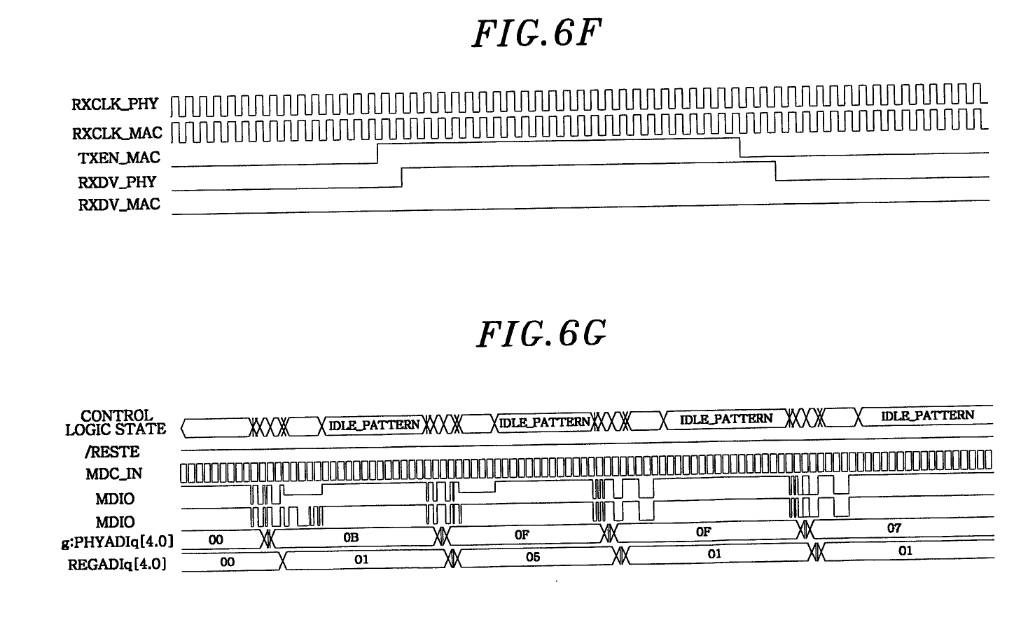

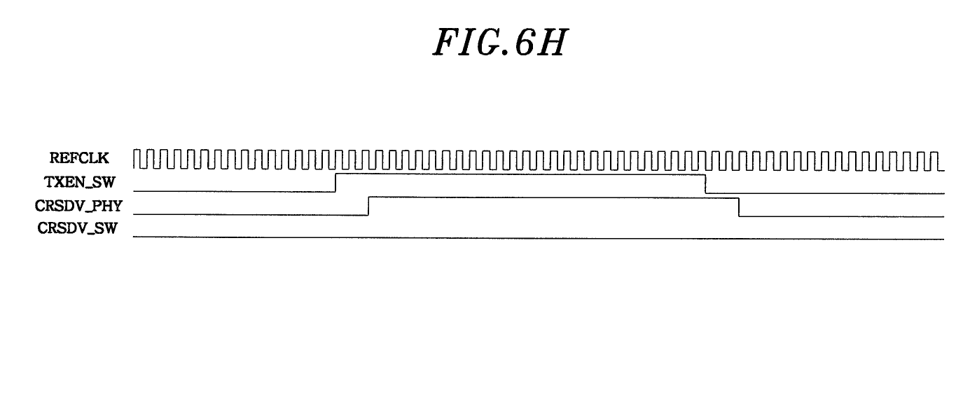

Therefore, in accordance with the present invention, the MIC 160 provides the PHY 120 with signals for setting the link pass establishment region 722 always to have a value representing a “link pass” state through a management data clock (MDC) terminal and an I/O management data input/output (MDIO) terminal of the PHY 120 as described in FIG. 6A. As a result, the PHY 120 can judge that its link partner, i.e., the PHY 220, is always connected thereto and normally operates without examining the NLP signal transmitted from the PHY 220. Thereafter, it is considered that the link between the link partners 100 and 200 is always activated regardless of whether or not the link partners 100 and 200 are connected to each other and normally operate.

Further, as afore-mentioned, in accordance with the present invention, since the input/output terminals RX+ and TX+ (or RX− and TX−) of the LAN card 100 are connected to each other through the signal line 50A (or 50B), the PHY 120 may receive back an AN signal outputted therefrom and mistake it as an AN signal transmitted from the PHY 220 of the switching hub 200. Therefore, it is improper to determine a maximum data transmission speed and a duplex mode between the link partners by using the result of the AN process, i.e., the AN signal.

Moreover, the duplex mode of the PHYs 120 and 220 should be decided as a full duplex mode, not a half duplex mode, because the transmission and receiving of data between the link partners 100 and 200 can be simultaneously accomplished in the full duplex mode, whereas the transmission and receiving of data are alternatively carried out in the half duplex mode. For instance, if the duplex modes of the PHYs 120 and 220 are set to the half duplex mode, the PHYs 120 and 220 can receive back data packets outputted therefrom through the input terminal RX+ or RX− and, thereafter, may judge that there always happens a data collision between the link partners.

Consequently, in accordance with the present invention, as shown in FIG. 6B, the MIC 160 sets the AN activation establishment region 712 to define “an AN inactivation state,” the speed selection region 714, “10 Mbps or 100 Mbps” and the duplex mode determination region 716, “a full duplex mode” by using the MDC and MDIO signals. Then, states of the data transmission speed and the duplex mode set at the basic register 710 are reported to the MAC 140 through the use of MDC and MDIO signals provided to the MAC 140, i.e., MCD_MAC and MDIO_MAC signals as described in FIG. 6C.

As described above, the basic register 710 is set by the MIC 160 connected inbetween the MAC 140 and the PHY 120. As a result, the present invention can accomplish the data communications through the pair of signal lines 50A and 50B by tying together an input terminal RX and an output terminal TX of the PHY 120.

TABLE 1
FTP Transmission Size: 160 Mbytes
Link Pass, AN Inactivation, 10 Mbps, Full Duplex

Present Invention

| | |
|---|---|
| Employing MICs | Prior Art |

| Data | | Data | |
|---|---|---|---|
| Transmission | | Transmission | |
| Time | Throughput | Time | Throughput |
| 41.8 sec | 3.21 Mbps | 14.2 sec | 9.45 Mbps |

In Table 1, there are exemplarily shown results of comparing the performance of the first embodiment of the present invention employing one pair of signal lines with that of the prior art using two pairs of signal lines when 160 Mbytes data is transmitted through a file transmission protocol (FTP) under a condition in which the data transmission speed is 10 Mbps and the duplex mode is the full duplex mode.

As can be seen from Table 1, in the Ethernet system further employing only the MICs in accordance with the first embodiment of the present invention, the data transmission time is about 3 times longer than that of the prior art and the throughput is about 3 times less than that of the prior art. In other words, when the MIC sets the basic register of the PHY to define therein the AN inactivation state, the 10 Mbps speed and the full duplex mode, and the additional register to define the link pass state, the performance of the inventive data communications using one pair of signal lines is deteriorated compared with that of the prior art. The deterioration of the performance of the present invention is due to an increased data packet loss caused by a data collision happening on the pair of signal lines when the link partners both try to transmit data packets at the same time.

Referring to FIG. 3, there is illustrated a second preferred embodiment of the present invention, which employs a data collision avoidance mechanism so as to reduce the data transmission time in the first embodiment shown in FIG. 2.

Since the second embodiment further includes MII controllers (MIICs) 380 and 480 in addition to the configuration of the first embodiment described in FIG. 2, the operation of the second embodiment will be explained mainly in association with the added components.

The MIIC 380 is employed to connect an MAC 340 with a PHY 320 of a LAN card 300 while the MIIC 480 is used to connect a PHY 420 to a switch controller 440 of a switching hub 400, to thereby perform the data collision avoidance mechanism.

The operation of the MIIC will be explained hereinbelow. Since the configurations of the LAN card 300 and the switching hub 400 are substantially identical to each other, the explanation for the MIIC is carried out only for the MIIC 380 of the LAN card 300.

First of all, as mentioned in the description of the first embodiment of the present invention, since each of the PHYs of the LAN card and the switching hub is set to execute the full duplex operation by its corresponding MIC, it is possible for each of the PHYs to transmit data packets to its link partner at the same time when receiving data packets from its link partner. Namely, each of the PHYs can transmit data packets to its link partner even while it is receiving data packets from its link partner. In this case, since an input line and an output line are separated in the prior art using two pairs of signal lines, there occurs no data collision during the data transmission. However, in the present invention using one pair of signal lines through which the input terminal and the output terminal are connected to each other, since data being transmitted and data being received can collide on a same signal line, which will cause damages to the data being transmitted and therefore the data should be re-transmitted.

Moreover, there happens a loop-back phenomenon between the LAN card and the switching hub since their input and output terminals are connected to each other through the pair of signal lines 50A and 50B. That is, according to the loop-back phenomenon, the LAN card and the switching hub can receive back data packets outputted therefrom during its data transmission. As a result, the LAN card or the switching hub mistakes the data packets outputted therefrom to its link partner for data packets transmitted from its link partner.

Therefore, at first, in order to prevent the data collision from happening during the data transceiving between the link partners, when there are generated at the MAC 340 new Ethernet data packets to be transmitted during the data receiving, the MIIC 380 delays the data transmission from the MAC 340 to the PHY 320. The data transmission delay is performed by using a characteristic of the MAC 340, which transmits data packets to the PHY 320 while it is synchronized with the transmit clock signal TXCLK_PHY provided from the PHY 320. As illustrated in FIG. 6D, the MIIC 380 performs the data transmission delay by converting the transmit clock signal TXCLK_PHY provided thereto from the PHY 320 to a transmit clock signal TXCLK_MAC maintaining a disabled state, e.g., a logic low state ‘0’, until the data receiving is completed, and providing the MAC 340 with the transmit clock signal TXCLK_MAC.

As a result, in response to the transmit clock signal TXCLK_MAC having the disabled state, the MAC 340 delays its data transmission until the data receiving is terminated.

Further, there could occur a data collision when both of link partners try to send their own data at the same time.

In order to prevent the data collision between the link partners, one of them delays its data transmitting time for a chosen duration after every data transaction, i.e., data transmitting or receiving. Maintaining the transmit clock signal TXCLK_MAC as the disabled state is also used for the delay. This is shown in FIG. 6E.

Secondly, to preclude the loop-back phenomenon of the Ethernet data packets from occurring, the MIIC 380 eliminates data packets looped back through an input terminal RX of the PHY 320 during the data transmission. The loop-back prevention is implemented by using a characteristic of the receive data valid signal RXDV that maintains a logic high state ‘1’ during the data transmission from the PHY 320 to the MAC 340, wherein the PHY 320 asserts the receive data valid signal RXDV having the logic high state when it receives valid data. Referring to FIG. 6F, it is noted that, when the data transmission is executed, the MIIC 380 provides a RXDV terminal of the MAC 340 with an RXDV_MAC signal having a logic low state by converting an RXDV_PHY signal supplied from the PHY 320 to have a disabled state, thereby preventing the MAC 340 from receiving the data packets looped back during its data transmission.

TABLE 2
FTP Transmission Size: 160 Mbytes
Link Pass, AN Inactivation, 10 Mbps, Full Duplex

Present Invention
Employing

| | |
|---|---|
| MICs and MIICs | Prior Art |

| Data | | Data | |
|---|---|---|---|
| Transmission | | Transmission | |
| Time | Throughput | Time | Throughput |
| 14.3 sec | 9.39 Mbps | 14.2 sec | 9.45 Mbps |

In Table 2, there are shown comparison results of the performance of the second embodiment of the present invention and that of the prior art using two pairs of signal lines when 160 Mbytes data is transmitted through the FTP under a condition in which the data transmission speed is 10 Mbps and the duplex mode is the full duplex mode.

As can be seen from Table 2, in the Ethernet system further employing the MICs and the MIICs, the data communications using one pair of signal lines has the performance substantially similar to that of the prior art.

Referring to FIG. 4, there is shown a block diagram of an Ethernet system in accordance with a third preferred embodiment of the present invention, which is configured to support a reduced pin count MII (RMII) protocol instead of the MII protocol supported by the first and the second preferred embodiment of the present invention. The configuration of the third embodiment is also practically identical with that of the second embodiment except for a part related to the RMII. Therefore, hereinafter, the Ethernet system in accordance with the third embodiment will be explained for a case in which a switching hub 600 supports the RMII protocol.

The RMII is an industrial standard interface for an Ethernet switch and is functionally identical to IEEE 802.3u MII. However, it uses smaller number of signals than the MII so as to reduce manufacturing costs and increase the number of physical layer ports of the switching hub by reducing the number of pins associated with each port. Therefore, in a system supporting the RMII protocol, TXCLK and RXCLK signals do not exist separately for each of the ports and, instead of them, there exists a reference clock signal REFCLK. Accordingly, the third embodiment cannot use the method disclosed in the second embodiment, which delays the data transmission during the data receiving by maintaining the transmit clock signal TXCLK to have the disabled state.

Therefore, in order to implement the data transmission delay in the third embodiment, likewise in the first and the second embodiment, an RMI controller (RMIC) 660 first sets the additional register 720 in a PHY 620 to define a link pass mode and establishes the regions 712, 714 and 716 of the basic register 710 in the PHY 620 to define an AN inactivation mode, 10 Mbps or 100 Mbps and a full duplex mode, respectively, by using the MDC and the MDIO signals.

Meanwhile, a switch controller 640 instructs the PHY 620 to perform an AN process, and reads therein from the PHY 620 a duplex mode and a data transmission speed determined through the AN process to thereby set itself to have the determined duplex mode and data transmission speed. At this time, the RMIC 660 is positioned in the midway of this path, sets the regions 712, 714 and 716 of the basic register 710 in the PHY 620 to have the AN inactivation mode, 10 Mbps or 100 Mbps, and the full duplex mode as described above, and reports to the switch controller 640 that the PHY 620 is set to have the certain data transmission speed and a half duplex mode as illustrated in FIG. 6G. As a result, since the duplex mode of the switch controller 640 is decided to be the half duplex mode through the above mode setting process performed by the RMIC 660 although the duplex mode of the PHY 620 was practically determined to be the full duplex mode, during the data receiving from the PHY 620, the switch controller 640 can avoid a data collision by performing a data transmission delay process for transmit data according to the half-duplex operation.

On the other hand, when the switch controller 640 outputs the transmit data to the PHY 620, an RMII controller (RMIIC) 680 converts a state of a carrier sense/data valid signal CRSDV_PHY generated by the PHY 620, which reports that there are data packets being transmitted from the PHY 620, from a logic high to a logic low, i.e., a disabled state, as shown in FIG. 6H, and provides a converted signal CRSDV_SW to a CRSDV terminal of the switch controller 640, wherein the CRSDV signal has the logic high state when there are data packets being transceived. As a result, since the switch controller 640 recognizes that there is no data provided from the PHY 620 and, thus, it does not receive any data packet, it is possible to make the switch controller 640 not receive data packets looped back through an input terminal RX of the PHY 620.

In accordance with a modification of the third embodiment, the method related to the RMII described in the third embodiment can be applied to the first and the second embodiment. That is, by setting the PHYs of the LAN card and the switching hub to have the full duplex mode and the switch controller to have the half duplex mode, the data transmission delay can be obtained during the data receiving.

In the preferred embodiments of the present invention, the switching controller can be substituted with the MAC.

Through the above processes, the present invention can carry out the data communications through one pair of signal lines without the performance deterioration in the Ethernet environment and, thereafter, can reduce the number of signal lines used in the data communications while taking advantages of the conventional Ethernet environment.

While the present invention has been described with respect to the particular embodiments, it will be apparent to those skilled in the art that various changes and modifications may be made without departing from the spirit and scope of the invention as defined in the following claims.

What is claimed is:

1. An Ethernet system for performing data communications between two link partners, which comprises:
a local area network (LAN) card;
a switching hub, connected to the LAN card, for performing the data communications with the LAN card; and
a pair of signal lines for connecting the LAN card and the switching hub,
wherein the LAN card and the switching hub become the link partners and each of them includes:
a physical layer interface (PHY), containing two output terminals TX+ and TX− and two input terminals RX+ and RX−, for forming an interface with its link partner, wherein the output terminal TX+ and the input terminal RX+ are attached to one of the signal lines and the output terminal TX− and the input terminal RX− are connected to the other of the signal lines;
a controller for transceiving data and control signals with the PHY; and
a control circuit for establishing a data transmission speed, a duplex mode, a link mode and an auto-negotiation (AN) activation state to be stored in the PHY and the controller.

2. The Ethernet system as recited in claim 1, wherein the PHY stores the AN activation state, the data transmission speed, the duplex mode and the link mode decided as AN inactivation, 10 Mbps or 100 Mbps, a full duplex mode and a link pass mode, respectively, by the control logic circuit.

3. The Ethernet system as recited in claim 2, wherein the controller becomes either a media access controller or a switching controller.

4. The Ethernet system as recited in claim 2, wherein the system supports a media independent interface (MII) protocol for the PHY and the controller.

5. The Ethernet system as recited in claim 4, wherein the control circuit sets the controller to have the same AN activation state, data transmission speed, duplex mode and link mode as those stored in the PHY.

6. The Ethernet system as recited in claim 5, wherein each of the LAN card and the switching hub further includes an additional control circuit, which is connected inbetween the PHY and the controller and delays data transmission to its link partner when receiving data from its link partner, to thereby avoid data collisions between the link partners.

7. The Ethernet system as recited in claim 6, wherein the additional control circuit performs the data transmission delay by providing the controller with a transmit clock signal maintaining a disabled state until the data receiving is completed, wherein the data transmission is carried out synchronously with respect to the transmit clock signal sourced by the PHY.

8. The Ethernet system as recited in claim 5, wherein each of the LAN card and the switching hub further includes an additional control circuit, which is used to connect the PHY with the controller and prevents transmit data outputted therefrom from being looped back thereto when the transmit data is transmitted to its link partner through the pair of signal lines, said additional control circuit preventing the transmit data looped back from being inputted to the controller.

9. The Ethernet system as recited in claim 8, wherein the additional control circuit implements the loop-back prevention by disabling a receive data valid signal provided from the PHY to the controller during the data transmission, wherein the PHY asserts the receive data valid signal having an enabled state when it receives valid data.

10. The Ethernet system as recited in claim 3, wherein the system supports a reduced pin count media independent interface (RMII) protocol.

11. The Ethernet system as recited in claim 10, wherein the control circuit sets the controller to have the same AN activation value, data transmission speed and link mode as those stored in the PHY while deciding the duplex mode as a half duplex mode.

12. The Ethernet system as recited in claim 11, wherein each of the LAN card and the switching hub further includes an additional control circuit, which connects the PHY to the controller and prevents transmit data outputted therefrom from being looped back thereto when the transmit data is transmitted to its link partner through the pair of signal lines, said additional control circuit preventing the transmit data looped back from being inputted to the controller.

13. The Ethernet system as recited in claim 12, wherein the additional control circuit implements the loop-back prevention by disabling a data valid signal provided from the PHY to the controller during the data transmission.
